(19) United States
(12) Patent Application Publication
(10) Pub. No.: US 2008/0205683 A1
(43) Pub. Date: Aug. 28, 2008

(54) EYEGLASS-MOUNTABLE AUDIO SYSTEM

(76) Inventor: Frank Michael Weyer, Los Angeles, CA (US)

Correspondence Address: TECHCOASTLAW, Suite 1224, 264 S. La Cienega Blvd., Beverly Hills, CA, 90211, US

(21) Appl. No.: 11/957,457

(22) Filed: Dec. 16, 2007

Related U.S. Application Data
(63) Continuation-in-part of application No. 11/301,045, filed on Dec. 12, 2005.
(60) Provisional application No. 60/642,339, filed on Jan. 7, 2005.

(51) Int. Cl. H04R 1/10

(52) U.S. Cl. 381/381; 381/374; 351/158

(57) ABSTRACT

The present invention comprises a method and apparatus for attaching earphones to eyeglass and similar frames. In one or more embodiments, the apparatus of the present invention comprises an earphone that comprises an elongated support arm that supports the earphone electronics and speaker unit. In one or more embodiments, the elongated support arm has a configuration such that it has a first free end, an elongated, typically curved center portion, and a second end to which the earphone speaker unit is attached. An expandable, resilient, tubular sleeve having a bore is slid over the free end such that it is disposed along the center portion. The combination of the earphone and resilient sleeve forms an audio unit that may be attached to a temple of an eyeglass frame by sliding the free end of the temple through the resilient sleeve until the temple's free end projects from the rear of the sleeve. The earphone and sleeve unit may be slid along the temple to adjust to the position of a user's ear. The earphone is thereby firmly yet adjustably and comfortably attached to the eyeglass frame temple. In one or more embodiments, the earphone comprises a Bluetooth cellular headset and/or a digital music player.

### CROSS-REFERENCE TO RELATED PATENT APPLICATION

This patent application is a continuation in part of, and claims the benefit of the filing date of U.S. patent application Ser. No. 11/301,045 filed on Dec. 12, 2005 for “Eyeglass-Mountable Earphone System (which claims the benefit of the filing date of Provisional U.S. Patent Application No. 60/642,339 filed on Jan. 3, 2005 for “Eyeglass-Mountable Earphones”), and also claims the benefit of the filing date of Provisional U.S. Patent Application No. 60/642,339 filed on Jan. 3, 2005 for “Eyeglass-Mountable Earphones,” both of which are incorporated by reference in their entireties herein.

### FIELD OF THE INVENTION

This invention relates to the field of portable wearable electronics, and in particular for a system for attaching earphones and headsets to eyeglass and similar frames.

A portion of the disclosure of this patent document contains material that is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND

Portable electronic devices, such as, for example, portable music players, radios, handheld electronic game players, portable video players, and mobile and cellular telephones, remain popular. Such devices typically utilize some type of earphone for delivering audio to the user's ears. Earphone types include small in-the-ear “ear buds” larger, headband mounted “headphones,” behind-the-neck “neckband” type earphones, and various other designs and configurations, including earphones combined or integrated with microphones and/or various electronic circuits and components (e.g. Bluetooth headsets, mp3 players, etc. (the term “earphone” as used herein encompasses earphones, headphones, cellular headsets, and in general any type of audio speaker that is intended to be maintained in or adjacent to a person's ear during use)).

Portable electronic audio devices are by their nature used in a non-stationary manner. A persistent problem is maintaining earphones comfortably in position during the user's movement, particularly when the user is engaging in activities like running, skating, skiing and other physical activities. Various prior art attempts have been made to retain earphones in place by securing them in some manner to eyeglass frames (the term “eyeglass” as used herein includes sunglasses and eyeglasses, with or without lenses, eyeglass frames, and eyeglass-like frames that may or may not be intended to be outfitted with lenses but that are worn in a manner similar to eyeglasses, including, without limitation, head-mounted video display systems that utilize eyeglass-type frames). One prior art system for attaching earphones to sunglasses is disclosed in U.S. Pat. No. 4,902,120, owned by the applicant. In that prior art system, which is used, for example, on the “Thump” MP3 player sunglasses sold by Oakley, Inc., an earphone speaker is attached to a support arm that is slidably and pivotably attached to temples of eyeglass frames. Although this system works fairly well, it requires specially designed frame-attachment components and does not allow for attachment and removal from a variety of user-selected eyeglasses.

There remains a need for a system that allows earphones to be easily, comfortably, and removably attached to eyeglass and similar frames.

### SUMMARY OF THE INVENTION

The present invention comprises a method and apparatus for attaching an earphone to eyeglass and similar frames. In one or more embodiments, the apparatus of the present invention comprises an earphone that comprises an elongated support arm that supports the earphone's speaker unit. The earphone may be specially designed for use with the present invention, or may be of an existing design that features an elongated support arm. Examples of such existing earphone designs that are usable with the present invention include, without limitation, “ear hanger” earphones (such as, for example, the h.ear Sports Headphones model MDRJ11G from Sony Corporation, the HS-320 model earphones from Philips Corporation, the KSC22 model earphones from Koss Corporation), clip-on earphones (such as the Jensen JHK02 model earphones from Thomson, Inc.), clip-on MP3 player headphones, cellular telephone headsets (including Bluetooth headsets), and typically any other earphones that comprise an elongated support arm, including support arms intended to fit around a users' ears. In one or more embodiments, the elongated support arm has a configuration such that it has a first free end, an elongated, typically curved center portion, and a second end to which the earphone speaker unit is attached. An expandable, resilient, tubular sleeve having a bore is slid over the free end such that it is disposed along the center portion. In one or more embodiments, the sleeve is formed of foam rubber or similar materials. The combination of the earphone and resilient sleeve forms an earphone unit that may be attached to a temple of eyeglasses by sliding the free end of the temple through the resilient sleeve until the temple's free end projects from the rear of the sleeve. The earphone/sleeve unit may be slid along the temple to adjust to the position of a user's ear. The earphone is thereby firmly yet adjustably and comfortably attached to the eyeglass temple. In one or more embodiment, the earphone comprises wireless communications circuitry, such as Bluetooth transceiver circuitry, and may include a microphone. In one or more embodiments, the earphone comprises a digital music player, such as an MP3 player. In one or more embodiments, the earphone comprises a digital music player combined with a Bluetooth transceiver. In one or more embodiments, two earphone units of the invention are mounted to opposition temples of eyeglasses to provide stereo sound.

### BRIEF DESCRIPTION OF THE DRAWINGS

FIG. 1 shows an example of an eyeglass frame, a tubular sleeve, and an earphone used in an embodiment of the invention.

FIG. 2 shows a piece of resilient material from which the sleeve of the invention is made in an embodiment of the invention.

FIG. 3 shows the piece of resilient material of FIG. 2 after it has been formed into a

FIG. 4 shows how the resilient sleeve may be mounted onto the earphone in the embodiment of FIG. 1.

FIG. 5 shows an assembly comprising the sleeve mounted onto the earphone of the embodiment of FIG. 1.

FIG. 6 shows how the earphone and sleeve assembly of FIG. 5 may be mounted onto the eyeglass frame of FIG. 1.

FIG. 7 shows the earphone and sleeve assembly of FIG. 5 mounted onto the eyeglass frame of FIG. 1.

FIG. 8 shows an embodiment of an earphone of the invention that comprises a cellular telephone headset.

FIG. 9 shows an embodiment of the invention in which earphones of the invention are attached to opposite temples of eyeglasses.

### DETAILED DESCRIPTION

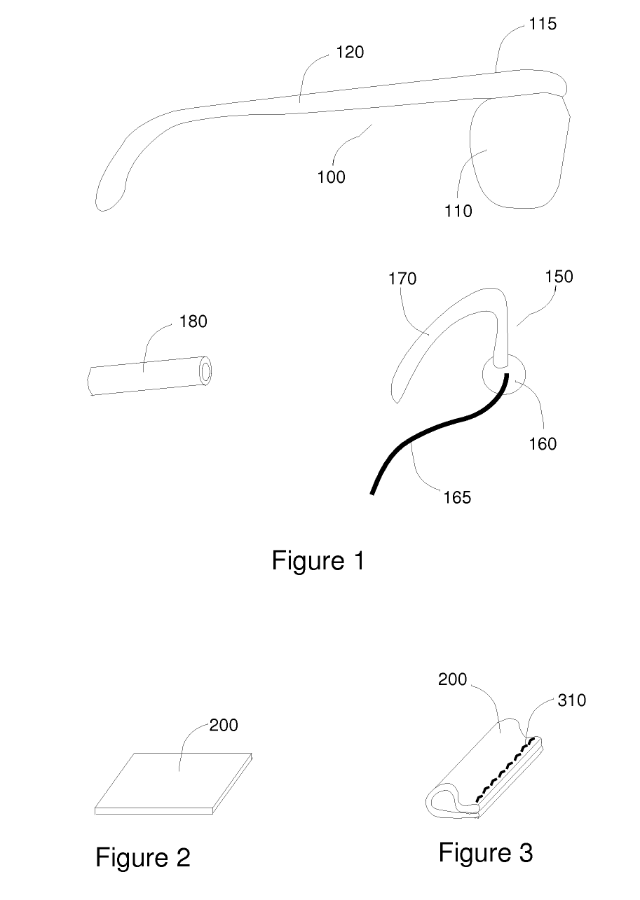

Embodiments of the invention will be discussed in regard to FIGS. 1 through 10.

FIG. 1 shows the components of an embodiment of the present invention. These components include a pair of eyeglasses 100, an earphone 150, and a resilient tubular sleeve 180.

Eyeglasses 100 are conventional eyeglasses comprising a lens or lenses 110 and a frame 15. Frame 115 comprises temples 120. In the view of FIG. 1, only the right temple 120 is visible.

Earphone 150 comprises an elongated support arm 170 that supports the earphone's speaker unit 160. Support arm 170 may be integrally formed with the housing of speaker unit 160, or may be separately formed and fixedly or removably, rigidly or movably, attached to speaker unit 160. Support arm 160 may be comprised of, for example, a rigid or flexible plastic, metal or metal wire, rubber or composite, or one or more thereof, as will be understood by those in the art. Earphone 150 may also include an electrical wire 165 for connection to a headphone jack of an electronic audio device. Embodiments of earphone 150 that comprise circuitry for wireless connection to an electronic audio device (e.g. a Bluetooth connection) may not include electrical wire 165. Earphone 150 may be specially designed for use with the present invention, or may be of an existing design that features an elongated support arm 170 appropriate for use with the invention. Examples of such existing earphone designs that are usable with the present invention include, without limitation, “ear hanger” earphones (such as, for example, the h.ear Sports Headphones model MDRJ11G from Sony Corporation, the HS-320 model earphones from Philips Corporation, the KSC22 model earphones from Koss Corporation), clip-on earphones (such as the Jensen JHK02 model earphones from Thomson, Inc.), clip-on MP3 player headphones, cellular telephone headsets, and typically any other earphones that comprise an elongated support arm, including support arms intended to fit around a users' ears.

Elongated support arm 170 has a configuration such that it has a first free end, an elongated, typically curved center portion (that may be intended to fit behind a person's ear), and a second end to which the earphone speaker unit 160 is attached. Support arm 170 may be rigid or flexible, and may be constructed of a variety of materials, including, without limitation, metal (including metal wire), plastic, silicone, rubber, rubberized plastic, and combinations thereof.

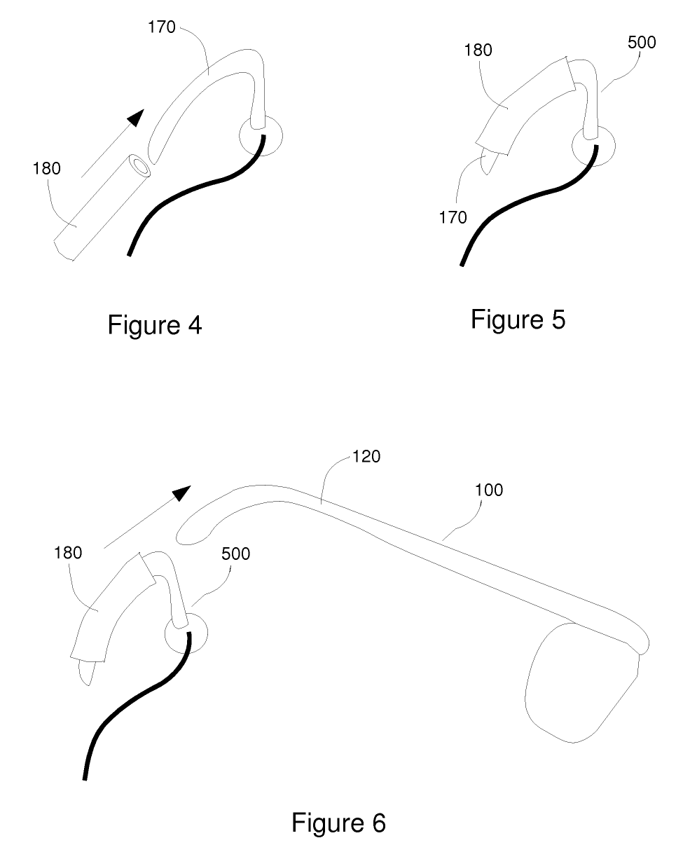

Tubular sleeve 180 comprises an expandable, resilient, sleeve having a bore and dimensioned so as to be able to be slid onto support arm 170 of earphone 150. Sleeve 180 may be created in a variety of manners and from a variety of materials, as will be understood by those of skill in the art. In one or more embodiments, sleeve 180 may be created, for example, by cutting the tubular end portions off of a CroakieXL neoprene eyeglass retainer; by knitting or weaving an elastic tube using conventional techniques; by molding or extruding foam rubber, EVA foam, or similar materials, or by folding in half a rectangle of a suitably-sized resilient material (for example fabric-coated neoprene or elastic webbing strap) such that the two folded edges coincide and then stitching along the coincident edges. Any material and fabrication technique may be used that produces a resilient, elastic tubular sleeve that can be slid over support arm 170 and that can expand sufficiently to allow the combination of earphone 150 and sleeve 180 to be slid onto an eyeglass frame temple, as explained in greater detail with respect to FIGS. 4 to 7 below. In one or more embodiments, a lubricant such as a silicone lubricant may be applied to the bore of the sleeve to assist in mounting onto support arm 170.

In one embodiment, earphone 150 is fashioned from a h.ear Sports Headphone Model MDRJ11G manufactured by Sony Corporation. This model earphone comprises an elongated support arm extending from the earphone speaker unit that is intended to fit over the user's ear when worn. The free end of the support arm has an expanded cross section significantly greater than the cross section of the remainder of the support arm. To construct one embodiment of the invention, the original Sony earphone was modified by heating the ear support arm section adjacent to the earphone speaker unit with a heat gun to soften the plastic to allow the angle in the arm to be increased from the original angle to an angle of approximately between 60 and 80 degrees.

In other embodiments, earphone 150 comprises un-altered off-the-shelf earphones, such as, for example, the model HS-320 model earphones from Philips Corporation and the KSC-22 model earphones from Koss Corporation. Typically, earphones having some flexibility in their support arms, such as the Philips HS-320 and Koss KSC-22 models, can be used without the alteration made to the Sony unit described above.

FIG. 2 shows a rectangular piece of resilient material 200 that may be used to form sleeve 180 in one or more embodiments of the invention. Resilient material 200 may comprise, for example, nylon-faced neoprene sheet up to about 3 mm thick. In one or more embodiments, resilient material 200 comprises elastic webbing (as is used, for example, in suspenders and waistbands). In one example, resilient material 200 comprises an approximately one-and-one-eighth inch to one-and-one-quarter inch long length of 2 in. wide elastic webbing, such as, for example, No. 900 2-inch, black elastic webbing sold by Lea & Sachs, Inc. This type of elastic webbing is elastic in the longitudinal direction (i.e. along its length), and less elastic in the transverse direction (i.e. along its approximately 2-inch width).

FIG. 3 shows how resilient material 200 of FIG. 3 may be formed into resilient tubular sleeve 180 in one or more embodiments of the invention. As shown in FIG. 3, resilient material 200 is folded in half along its longer (e.g. 2-inch) axis such that its approximately 2-inch long edges coincide, forming a folded material approximately 2 inches by 9/16 inches in size. The coinciding edges are then joined together, creating tubular sleeve 180. In the embodiment of FIG. 3, the edges are joined together by sewing or stitching, creating a seam 310. Any appropriate sewing stitch may be used. Any other method known to those of skill in the art for joining folded edges together may be used, including, without limitation, using an appropriate adhesive, or sonic or heat welding.

In one embodiment, tubular sleeve 180 is fabricated by cutting off an approximately two inch long tubular end portion of a CroakiesXL neoprene eyeglass retainer. A CroakiesXL eyeglass retainer consists of an approximately one-inch wide strip of neoprene rubber approximately 1/16.sup.th of an inch thick, fabric coated on one side, and 16 inches long. Croakies type eyeglass retainers are further described in U.S. Pat. No. 4,133,604, which is incorporated by reference herein. The first two inches of each end of the strip are formed into tubular sections by folding and stiching. These tubular sections are removed from the remainder of the strap by cutting across the strap with a pair of scissors to create two approximately two-inch long and one-half inch wide tubular sleeves 180. In one or more embodiments, tubular sleeves 180 may be formed from an approximately two inch by one inch to one-and-one quarter-inch strip of thin, fabric coated neoprene in a similar manner as described in U.S. Pat. No. 4,133,604. In one or more embodiments, tubular sleeves 180 may be comprised of rubber or other elastomeric materials (including foam rubber or EVA foam); may be formed from flat material; or may be directly woven or otherwise formed into seamless elastic tubing.

FIGS. 4 to 7 show how components of the invention may be assembled together in one or more embodiments of the invention. As shown in FIGS. 4 and 5, tubular sleeve 180 is slid over the free end of elongated arm 170 until that free end protrudes from tubular sleeve 180, leaving tubular sleeve 180 disposed generally along a midsection of elongated arm 170, as shown in FIG. 5. The combination of tubular sleeve 180 and earphone 150 creates a eyeglass-mountable earphone unit 500.

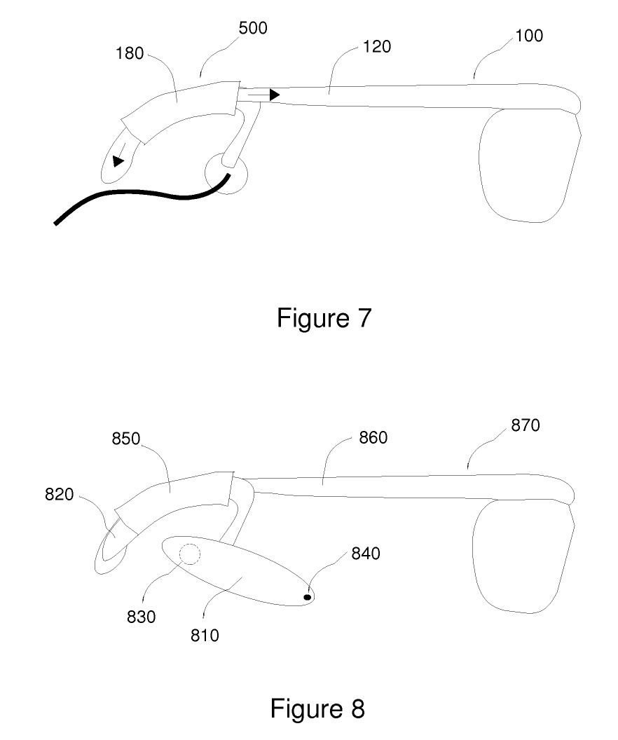

FIGS. 6 and 7 show how eyeglass-mountable earphone unit 500 is mounted to an eyeglass frame in one or more embodiments of the invention. As shown in FIG. 6, the free end of temple 120 of eyeglasses 100 is inserted into the bore of tubular sleeve 180 adjacent to elongated arm 170 (which is already disposed in the bore of tubular sleeve 180). The resilient nature of tubular sleeve 180 allows its bore to expand to accommodate temple 120 as well as elongated arm 170. Eyeglass-mountable earphone unit 500 may then be positioned along temple 120 in whatever position is most appropriate for a particular user so that the speaker units 160 are positioned adjacent the user's ear when eyeglasses 100 are worn.

In one embodiment, a tubular sleeve created by cutting an end off of a CroakiesXL eyeglass retainer is slid over the free end of the ear support arm of the modified Sony MDRJ11G earphone described above. Because of the resilient, elastomeric quality of neoprene, the sleeve is able to expand sufficiently to slide over the expanded free end section of the support arm. Then, once the sleeve has traversed the expanded section, it can contract such that it remains in position along the thinner ear support arm section between the speaker unit and the free end.

In one or more embodiments, an eyeglass-mountable earphone of the invention is attached to each of left and right temples of eyeglasses. Such a configuration is suitable for listing to stereo music. In other embodiments, only one eyeglass-mountable earphone may be mounted to one temple. Such a configuration is suitable when using the earphone with a cellular telephone, for example, or when it is desirable to leave one ear unobstructed.

FIG. 8 shows an embodiment of the invention in which the eyeglass-mountable earphone 810 comprises a cellular telephone headset. In the embodiment of FIG. 8, earphone 810 comprises a Bluetooth headset comprising a flexible support arm 820, a speaker 830 (located on the far side of earphone 810 in FIG. 8, shown by a dotted line), a microphone 840, as well as a Bluetooth transceiver, a rechargeable battery, and operating controls, as are known in the art. In one or more embodiments, earphone 810 comprises a Motorola H500 or H670 Bluetooth headset. However it will be understood that any appropriate headset may be used. In the embodiment of FIG. 8, earphone 810 comprises a flexible support arm 820 whose configuration has, if necessary, been altered from its original configuration to reduce the curvature of support arm 820 in a manner analogous to that described above with respect to the Sony MDRJ11G model earphones. In the embodiment of FIG. 8, a resilient EVA foam sleeve 850 is disposed along support arm 820. Earphone 810 is mounted via sleeve 850 on temple 860 of eyeglasses 870.

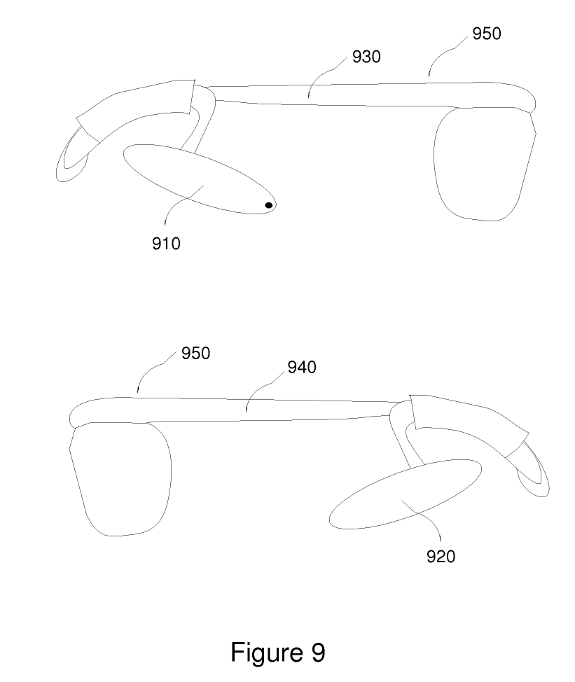

FIG. 9 shows an embodiment of the invention in which two earphones 910 and 920 are mounted to opposite temples 930 and 940, respectively, of eyeglasses 950. In one or more embodiments, earphones 910 and 920 each comprise radio transceivers, such as, for example, Bluetooth transceivers, and preferably include rechargeable batteries. In one or more embodiments, at least one of earphones 910 and 920 also comprises a digital music player, for example, an MP3 music player. In one embodiment, earphone 920 comprises a stereo digital music player comprising flash memory for storing digital music data. In one embodiment, earphone 920 is configured to play one channel of a stereo music stream when the digital music player is operating, while the second channel is broadcast via earphone 920's Bluetooth transceiver to earphone 910, which then plays the second channel. In one or more embodiments, earphone 910 comprises a cellular telephone headset such that it can alternately be connected via its Bluetooth transceiver to a cellular telephone, to earphone 920, or to other devices comprising Bluetooth transceivers. In one or more embodiments, one or both of earphones 910 and 920 comprises both a digital music player and a Bluetooth cellular telephone headset.

An advantage of the eyeglass-mountable earphone of the present invention is that it can easily be attached and removed from an eyeglass frame, it is adjustable to accommodate various users and eyeglasses, it is comfortable, and it firmly retains both the earphone speakers and the eyeglass frame in position when worn.

Although the present invention has been described with respect to particular embodiments, it will be understood by those of skill in the art that the invention is not limited to those particular embodiments, but includes alternative embodiments that will be evident to those skilled in the art. For example, although the earphone of the present invention has been described as being mountable to eyeglass frames, in one or more embodiments, it may also be mounted on frames for other wearable devices, such as, for example, head-mounted video displays, head-mounted lights, etc.

1. An eyeglass-mountable earphone comprising:
an elongated support arm;
a tubular sleeve disposed along said support arm;
a cellular telephone headset.

2. The earphone of claim 1 wherein said headset comprises a wireless headset.

3. The earphone of claim 2 further wherein said headset comprises a Bluetooth transceiver.

4. The earphone of claim 3 wherein said support arm is comprised of a rigid plastic material.

5. The earphone of claim 3 wherein said support arm is comprised of a flexible plastic material.

6. The earphone of claim 1 wherein said elongated support arm is shaped to fit around a wearer's ear.

7. The earphone of claim 1 wherein said tubular sleeve is comprised of a resilient material.

8. The earphone of claim 7 wherein said tubular sleeve is comprised of EVA foam tubing.

9. An eyeglass-mountable earphone comprising:
an elongated support arm;
a tubular sleeve disposed along said support arm;
a digital music player.

10. The earphone of claim 9 further comprising a Bluetooth transceiver.

11. The earphone of claim 9 wherein said support arm is comprised of a rigid plastic material.

12. The earphone of claim 9 wherein said support arm is comprised of a flexible plastic material.

13. The earphone of claim 9 wherein said elongated support arm is shaped to fit around a wearer's ear.

14. The earphone of claim 9 wherein said tubular sleeve is comprised of a resilient material.

15. The earphone of claim 14 wherein said tubular sleeve is comprised of EVA foam tubing.

16. A wearable audio system comprising:
a frame comprising first and second temples;
a first earphone comprising a first elongated support arm and a first wireless transceiver;
a first resilient tubular sleeve comprising a bore in which a portion of said first elongated support arm and a portion of said first temple are disposed.

17. The audio system of claim 16 further comprising:
a second earphone comprising a second elongated support arm and a second wireless transceiver;
a second resilient tubular sleeve comprising a bore in which a portion of said second elongated support arm and a portion of said second temple are disposed.

18. The audio system of claim 16 wherein said second earphone comprises circuitry for storing and playing digital audio.

19. The audio system of claim 18 wherein said second earphone is capable of wireless communication with said first earphone.

20. The audio system of claim 13 wherein said first earphone comprises a cellular telephone headset.
